(19) United States
(12) Patent Application Publication
(10) Pub. No.: US 2020/0160891 A1
(43) Pub. Date: May 21, 2020

(54) CD DRIVER ARRAY CABINET

(71) Applicant: Jiangsu Fine Storage Information Technology Co., Ltd., Changshu City (CN)

(72) Inventors: Yilin LIU, Wuhan City (CN); Hui LUO, Changsha County (CN)

(73) Assignee: Jiangsu Fine Storage Information Technology Co., Ltd., Changshu City (CN)

(21) Appl. No.: 16/196,176

(22) Filed: Nov. 20, 2018

(51) Int. Cl. G11B 33/12; G11B 33/04

(52) U.S. Cl. CPC G11B 33/128; G11B 33/0461; G11B 33/126

(57) ABSTRACT

A CD driver array cabinet includes a storage bin. A supporting frame is arranged in the storage bin and is provided with a plurality of mounting sites arrayed in rows and columns. Processing units are installed in the mounting sites. Each processing unit includes a box and at least one CD driver, and the box has an open front side and a back side provided with a connecting plate, a circuit board is installed on the back side of the connecting plate, and the CD drivers are installed in the box. The CD driver array cabinet can process a large batch of CDs at the same time and facilitate unified management of CDs, thereby improving work efficiency and being convenient to maintain.

### FIELD

The invention belongs to the technical field of CD processing facilities, in particular to a CD driver array cabinet.

### BACKGROUND

Compact disc drivers, (CD drivers), are used for reading data from or writing data into CDs, which are carriers used for storing data information. With the advantages of high capacity, low cost, good stability, long service life, portability and the like, CDs have been widely applied to various industries and are of greater importance for storage and management of various data, particularly in the big data era. However, today, under the information explosion circumstance that people are facing a huge mass of data, it will take a long time to read data from or write data into CDs with CD drivers, and management of such a huge mass of data is also a great challenge. In view of this, it is a technical issue urgently to be settled to improve the processing efficiency and management efficiency of CD drivers.

### SUMMARY

To solve the technical problems mentioned above, the invention provides a CD driver array cabinet which is high in work efficiency and convenient to maintain.

The following technical solution is adopted by the invention to solve the aforesaid technical problems:

A CD driver array cabinet comprises a storage bin, wherein a supporting frame is arranged in the storage bin, a plurality of mounting sites are formed on the supporting frame in rows and columns, and processing units are installed in the mounting sites.

Preferably, each processing unit comprises a box and at least one CD driver, wherein the box has an open front side and a back side provided with a connecting plate, a circuit board is installed on the back side of the connecting plate, and the CD drivers are installed in the box. The processing units are installed on the storage bin in the following way: the processing units are inserted into the mounting sites from the back side of the storage bin to attach the connecting plates on the back sides of the processing units to the supporting frame of the storage bin, and then the processing units are connected and fixed to the storage bin with bolts.

Preferably, the CD drivers are arranged layer-by-layer. By full utilization of the flat rectangular outline structure of the CD drivers, the CD drivers can be reasonably arrayed layer-by-layer.

Preferably, cooling windows are arranged on the upper face and side faces of each box and are used for dissipating heat generated when the CD drives work, thus, prolonging the service life of the CD drivers.

Preferably, threaded holes to be connected with the CD drivers through bolts are formed in the side faces of each box and are transverse strip-shaped holes. The CD drivers are existing products and are independent structures connected with the boxes through bolts, thereby being convenient to assemble and disassemble. The threaded holes are transverse strip-shaped holes and are used for adjusting the positions of the CD drivers arrayed layer-by-layer, so that trays of all the CD drivers in each box are located on the same center line.

Preferably, the number of the CD drivers in each box is four, and the four CD drivers form a CD driver array unit, so that the processing unit is prevented from being too heavy and thus can be assembled and disassembled conveniently.

Preferably, the number of the mounting sites is twenty-seven, and the twenty-seven mounting sites are arrayed in nine rows and three columns.

Preferably, electric boxes and wiring troughs are installed on the supporting frame and are located between every two columns of mounting sites. The electric boxes are located on the front side of the CD driver array cabinet. The wiring troughs are located on the back side of the CD driver array cabinet. The wiring troughs and the circuit boards of the processing units are all located on the back side of the storage bin, so that the layout is reasonable, and wiring is convenient. Transformers are installed in the electric boxes and are connected with a power supply.

Preferably, cooling fans are installed at the top of the storage bin and are used for dissipating heat in the storage bin.

Preferably, laser ranging sensors used for detecting trays of the CD drivers are installed at the bottom of the front side of the storage bin. Because the CD drivers are placed on or taken from the CD driver trays by an intelligently-controlled mechanical gripper, in order to prevent the situation that the trays fail to retreat into the CD drivers due to faults after being ejected out, which may otherwise result in damage to the trays due to collision with the mechanical gripper, detection needs to be carried out. Particularly, the laser ranging sensors are installed on the projection plane of the trays, ejected out of the CD drivers, on the bottom surface of the storage bin, laser light emitted by the laser ranging sensors vertically spreads upwards and is reflected back after being shielded by the top surface of the storage bin or trays, and then a control system works out the distance from each laser ranging sensor to the corresponding shield to determine whether or not the trays are normal. If the laser light is shielded by the top surface of the storage bin, the distance is the maximum, and all is considered normal. If the laser light is shielded by a tray, there is something wrong with the tray, and the broken tray is specified by detecting the distance from the tray to the corresponding sensor and is accurately positioned to be repaired in time.

The invention has the following beneficial effects: one processing unit is formed by a plurality of CD drivers, a plurality of processing units are installed in the storage bin to form the CD driver array cabinet, and the CD drivers are densely arrayed, so that a large batch of CDs can be processed at the same time and can be managed in a unified manner, thus, remarkably improving work efficiency; the processing units are independent of one another, so that when one CD driver breaks down, only the processing unit to which the broken CD driver belongs needs to be disassembled to be rapidly replaced with a new one, thus, realizing continuous production without stopping machines/lines; and afterwards, the disassembled processing unit is conveniently repaired by replacing the broken CD driver with a new one.

### BRIEF DESCRIPTION OF THE FIGURES

FIG. 1 is a structure view of installing CD drivers of a CD driver array unit of the invention;

FIG. 2 is an overall structural view of the CD driver array unit of the invention;

FIG. 3 is a back view of a CD driver array cabinet before processing units are installed;

FIG. 4 is a front view of the CD driver array cabinet after the processing units are installed; and

FIG. 5 is a back view of the CD driver array cabinet after the processing units are installed.

Reference signs: box 1; CD driver 2; connecting plate 3; circuit board 4; cooling window 5; threaded hole 6; storage bin 7; supporting frame 8; mounting site 9; electric cabinet 10; wiring trough 11; cooling fan 12; laser ranging sensor 13.

### DETAILED DESCRIPTION

The invention is further expounded and explained below with reference to the accompanying drawings and embodiments.

### Embodiment 1

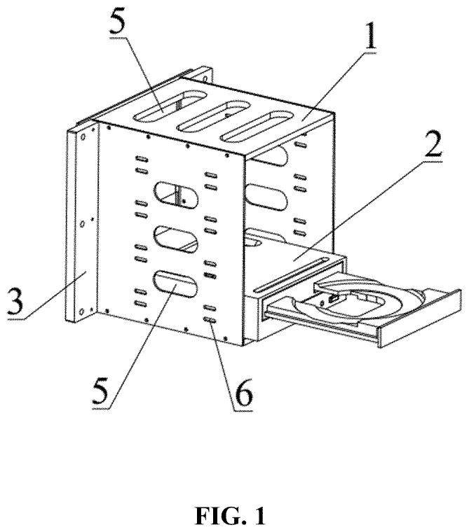

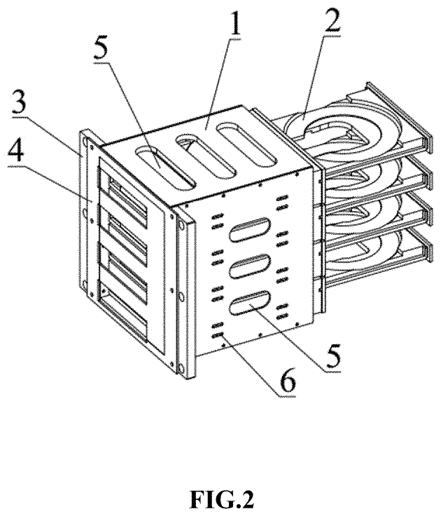

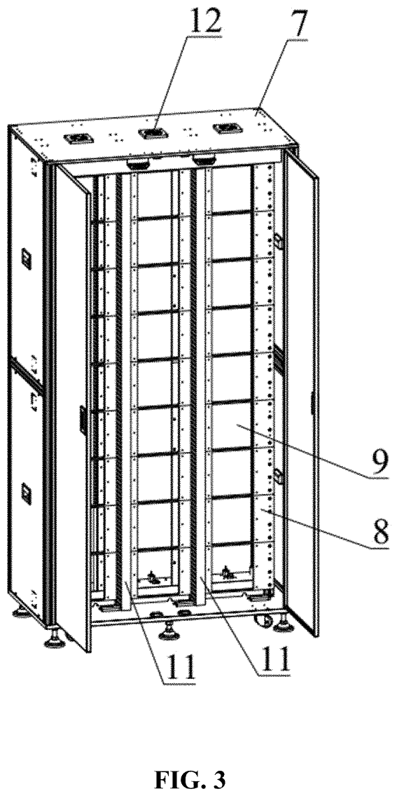

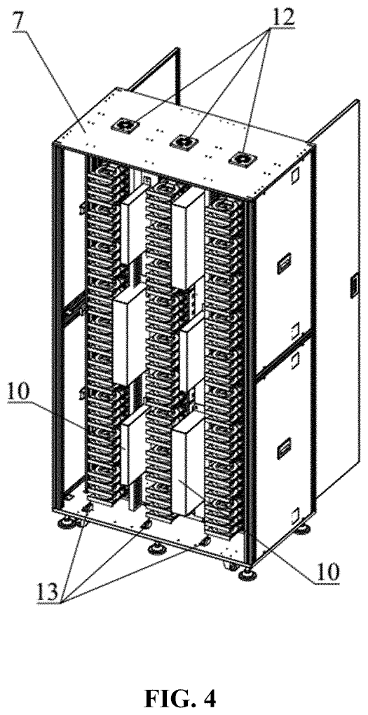

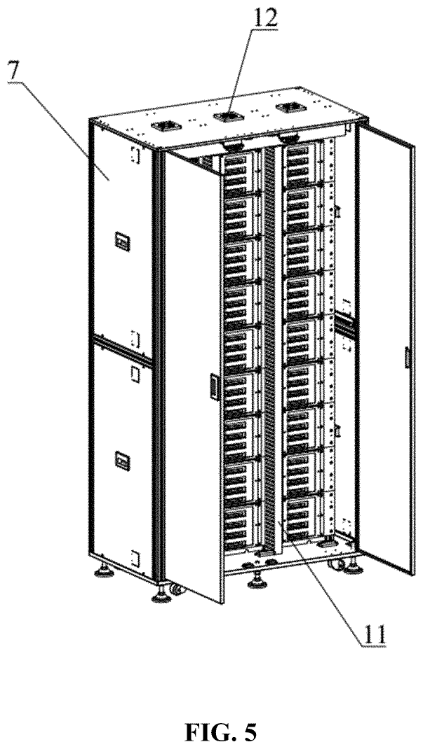

As shown in FIGS. 1-5, a CD driver array cabinet comprises a storage bin 7. A supporting frame 8 is arranged in the storage bin 7. A plurality of mounting sites 9 are formed on the supporting frame 8 in rows and columns. Processing units are installed in the mounting sites 9.

Each processing unit comprises a box 1 and at least one CD diver 2, wherein the box 1 has an open front side and a back side provided with a connecting plate 3, a circuit board 4 is installed on the back side of the connecting plate 3, and the CD drivers 2 are installed in the box 1.

The CD drivers 2 are installed layer-by-layer. By full utilization of the flat rectangular outline structure of the CD drivers, the CD drivers can be reasonably arrayed layer-by-layer.

Cooling windows 5 are arranged on the upper face and side faces of each box 1 and are used for dissipating heat generated when the CD drivers work, thus, prolonging the service life of the CD drivers.

Threaded holes 6 to be connected with the CD drivers 2 through bolts are formed in the side faces of each box 1 and are transverse strip-shaped holes. The CD drivers are existing products and are independent structures connected with the boxes through bolts, thereby being convenient to assemble and disassemble. The threaded holes are transverse strip-shaped holes and are used for adjusting the positions of the CD drivers arrayed layer-by-layer, so that trays of all the CD drivers in each box are located on the same center line.

The number of the CD drivers 2 in each box is four, and the four CD drivers 2 form a CD driver array unit, so that the processing unit is prevented from being too heavy and thus can be conveniently assembled and disassembled.

This embodiment has the following beneficial effects: each processing unit serves as a CD driver array unit formed by four CD drivers, which are installed in the box one by one and connected with the box through bolts, then the circuit board is connected to the four CD drivers, afterwards, the positions of the four CD drivers are corrected to align the centers of trays of the CD drivers, and finally, the bolts are fastened to complete installation and correction of the processing unit; afterwards, the processing unit is inserted into one mounting site from the back side of the storage bin to attach the connecting plate on the back side of the processing unit to the supporting frame of the storage bin, and finally, the processing unit is connected and fixed to the supporting frame with bolts through simple operation.

### Embodiment 2

As shown in FIGS. 1-5, on the basis of embodiment 1, the number of the mounting sites is twenty-seven, and the twenty-seven mounting sites are arrayed in nine rows and three columns.

Electric boxes 10 and wiring troughs 11 are installed on the supporting frame 8 and are located between every two columns of mounting sites 9. The electric boxes 10 are located on the front side of the CD driver array cabinet. The wiring troughs 11 are located on the back side of the CD driver array cabinet. The wiring troughs and the circuit boards of the processing units are all located on the back side of the storage bin, so that the layout is reasonable, and wiring is convenient. Transformers are installed in the electric boxes and are connected with a power supply.

Cooling fans 12 are installed at the top of the storage bin 7 and are used for dissipating heat in the storage bin. In this embodiment, corresponding to the three columns of processing units, three cooling fans are installed to improve the cooling effect.

This embodiment has the following beneficial effects: one processing unit is formed by a plurality of CD drivers, a plurality of processing units are installed in the storage bin to form the CD driver array cabinet, and the CD drivers are densely arrayed, so that a large batch of CDs can be processed at the same time and can be managed in a unified manner, thus, remarkably improving work efficiency.

### Embodiment 3

As shown in FIGS. 1-5, on the basis of embodiment 2, laser ranging sensors 13 used for detecting trays of the CD drivers 2 are installed at the bottom of the front side of the storage bin 7. Because the CD drivers are placed on or taken from the CD driver trays by an intelligently-controlled mechanical gripper, in order to prevent the situation that the trays fail to retreat into the CD drivers due to faults after being ejected out, which may otherwise result in damage to the trays due to collision with the mechanical gripper, detection needs to be carried out.

The laser ranging sensors are installed on the projection plane of the trays, ejected out of the CD drivers, on the bottom surface of the storage bin, laser light emitted by the laser ranging sensors vertically spreads upwards and is reflected back after being shielded by the top surface of the storage bin or trays, and then a control system works out the distance from each laser ranging sensor to the corresponding shield to determine whether or not the trays are normal. If the laser light is shielded by the top surface of the storage bin, the distance is the maximum, and all is considered normal. If the laser light is shielded by a tray, there is something wrong with the tray, and the broken tray is specified by detecting the distance from the tray to the corresponding sensor and is accurately positioned to be repaired in time. In this embodiment, corresponding to the three columns of processing units, three laser ranging sensors are installed.

This embodiment has the following beneficial effects: the processing units are independent of one another, so that when one CD driver breaks down, only the processing unit to which the broken CD driver belongs needs to be disassembled to be rapidly replaced with a new one, thus, realizing continuous production without stopping machines/lines; and afterwards, the disassembled processing unit is conveniently repaired by replacing the broken CD driver with a new one.

Under the enlightenment of the above ideal embodiments of the invention, various alterations and modifications can be made by those skilled in this field without deviating from the technological thought of the invention. The technical scope of the invention is by no means limited to the contents in the specification and should be defined in terms of the claims when necessary.

1. A CD driver array cabinet, comprising:
a storage bin, wherein a supporting frame is arranged in the storage bin and is provided with a plurality of mounting sites arrayed in rows and columns, and processing units are installed in the mounting sites,
wherein each processing unit comprises a box and at least one CD driver, each box has an open front side and a back side provided with a connecting plate, a circuit board is installed on a back side of each connecting plate, and the CD drivers are installed in the boxes, and wherein laser ranging sensors used for detecting CD driver trays are installed at a bottom of a front side of the storage bin.

2. (canceled)

3. The CD driver array cabinet according to claim 1, wherein the CD drivers are installed layer-by-layer.

4. The CD driver array cabinet according to claim 1, wherein cooling windows are arranged on an upper face and side faces of each said box.

5. The CD driver array cabinet according to claim 4, wherein threaded holes to be connected with the CD drivers through bolts are formed in the side faces of each said box and are transverse strip-shaped holes.

6. The processing unit according to claim 3, wherein the number of the CD drivers is four.

7. The CD driver array cabinet according to claim 1, wherein the number of the mounting sites is twenty-seven, and the twenty-seven mounting sites are arrayed in nine rows and three columns.

8. The CD driver array cabinet according to claim 7, wherein electric boxes and wiring troughs are installed on the supporting frame and located between every two columns of said mounting sites, the electric boxes are located on a front side of the CD driver array cabinet, and the wiring troughs are located on a back side of the CD driver array cabinet.

9. The CD driver array cabinet according to claim 1, wherein cooling fans are installed at a top of the storage bin.

10. (canceled)
